(19) United States
(12) Patent Application Publication
(10) Pub. No.: US 2010/0050514 A1
(43) Pub. Date: Mar. 4, 2010

(54) PLANT SUBSTRATE BASED ON OPEN-CELLED MELAMINE/FORMALDEHYDE FOAM

(75) Inventors: Alexander Wissemeier, Speyer (DE); Wolfgang Weigelt, Dudenhofen (DE); Armin Alteheld, Bad Kreuznach (DE); Horst Baumgartl, Mainz (DE); Hans-Jürgen Quadbeck-Seeger, Bad Durkheim (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/517,703

(22) PCT Filed: Dec. 5, 2007
(86) PCT No.: PCT/EP2007/063345

§ 371 Date: Jun. 4, 2009

(30) Foreign Application Priority Data
Dec. 6, 2006 (EP) 06125531.1

(51) Int. Cl. A01G 31/00; C08J 9/00; A01N 59/00; C05F 11/00

(52) U.S. Cl. 47/59 S; 521/188; 504/101; 71/27

(57) ABSTRACT

A plant substrate consisting of
(a) 25 to 100% by weight of an open-celled melamine/formaldehyde foam,
(b) 0 to 75% by weight of other synthetic plant substrates and/or mineral soil and
(c) 0 to 25% by weight of one or more systems for releasing active substances and/or of other additives,
   can be stored and transported in the absence of any water and makes possible a good aeration in the soil.

The invention relates to a synthetic plant substrate and to its use for growing plants.

The German utility model G 94 02 159.7 U1 discloses a soil conditioner which comprises peat and an open-celled flocculent melamine/formaldehyde foam, it also being possible to add planting compost, cutting compost or grave topsoil. The soil conditioner is flowable and is introduced into the soil.

Plants in flower pots or plant containers must be irrigated more often than those which grow directly in the soil (for example in flower beds) since the amount of soil in the pot limited. Turf plants and certain other garden plants, too, are sensitive to drought and must be irrigated frequently. The water holding capacity of the abovementioned soil conditioner is not always satisfactory in these applications.

The German utility model DE 20 2005 018 041 U1 therefore proposes water-storing webs made of an open-celled melamine/formaldehyde foam which are in contact with plant compost or with the soil.

However, even with regard to this invention, there is still room for improvements, in particular concerning the substrate itself, in which the plant roots grow.

The reason is, inter alia, that the substrate requirements in modern plant production are very high.

In comparison with natural soil or natural substrates such as peat, this should have a series of advantages, such as
simplification of irrigation, high water-holding capacity which, in the case of irregular watering, compensates for an excessive supply of the plants with water, or lack thereof,
even when the amount of water absorbed is very high, the substrate should make possible the permeation of oxygen into the root zone,
the uptake and release of water should entail only minor changes in the substrate's volume,
the substrate should be easy to introduce into the container to be planted up and optimally utilize the volume to be planted up,
planting the plants into the substrate, and removing them therefrom, should be simple,
the plant roots should be held sufficiently stably in the substrate,
systems for releasing active compounds should be incorporated in a simple manner (for example fertilizers or plant protection agents) and
it should be possible for the substrate to be sterilized and to be reused.

It has been found that a substrate based on open-celled melamine/formaldehyde foams meets the abovementioned requirements to a high degree and dispenses with an addition of peat.

The invention therefore relates to a plant substrate consisting of

(a) 25 to 100% by weight of an open-celled melamine/formaldehyde foam,
(b) 0 to 75% by weight of other synthetic plant substrates and/or mineral soil and
(c) 0 to 25% by weight of one or more systems for releasing active substances and/or of other additives.

The substrate according to the invention can be stored and transported in the absence of any water without developing hydrophobic properties as is the case for example with peat-based substrates. The use according to the invention results in an outstanding aeration, and irrigation is considerably simplified.

The invention furthermore relates to the use of a mixture consisting of

(a) 25 to 100% by weight of an open-celled melamine/formaldehyde foam,
(b) 0 to 75% by weight of other synthetic plant substrates and/or mineral soil and
(c) 0 to 25% by weight of one or more systems for releasing active substances and/or of other additives,

as substrate for culturing plants.

The invention also relates to a method of culturing plants, where the plants are grown in a substrate consisting of

(a) 25 to 100% by weight of an open-celled melamine/formaldehyde foam,
(b) 0 to 75% by weight of other synthetic plant substrates and/or mineral soil and
(c) 0 to 25% by weight of one or more systems for releasing active substances and/or of other additives.

All percentages always relate to the total weight of the plant substrate according to the invention. Preferably, the plant substrate is essentially peat-free.

Suitable foams are all open-celled foams made of melamine/formaldehyde condensation resins. Especially preferred are elastic foams based on melamine resins as they are described in EP 0 017 672 A1. This publication is expressly referred to. Such foams are available, for example, from BASF Aktiengesellschaft under the name Basotect®.

For the purposes of the invention, an open-celled foam is understood as meaning a foam where the polymer forms a branched structure formed by discrete ribs and the individual bubbles which are the result of the foaming process are connected with one another. In contrast, a closed-cell foam is a foam where individual bubbles are surrounded completely by the polymer material and where the individual foam bubbles are separated from one another by polymer membranes, even in the finished foamed and cured polymer.

An open-celled foam which is suitable for the production of blocks or webs made of foam particles in accordance with the inventive process preferably has a pore volume of at least 0.95 m³/m³, preferably of at least 0.98 m³/m³ and in particular of at least 0.985 m³/m³. The term pore volume is understood as meaning the ratio of the pore volume relative to the foam volume. The length of the ribs in the open-celled foam increases with increasing pore volume values. At the same time, the rib diameter decreases.

The net specific gravity of such a foam is, for example, 4 to 100, preferably 6 to 60, in particular 8 to 40 and especially preferably 8 to 20 g/l as specified in DIN 53420.

To produce such a foam, a highly concentrated, propellant-comprising solution or dispersion of a melamine/formaldehyde precondensate can be foamed using hot air, steam or the effect of microwaves and then cured, as described in EP-A 071 672 or EP-A 037 470.

The molar ratio of melamine/formaldehyde is generally in the range of from 1:1 to 1:5. To prepare foams which are especially low in formaldehyde, the molar ratio is selected in the range of from 1:1.3 to 1:1.8, and a sulfite-free precondensate is employed, as described for example in WO 01/94436.

Very especially preferred are elastic foams which are based on a melamine/formaldehyde condensate which comprises incorporated into the polymer at least 50% by weight, preferably at least 80% by weight, of melamine and formaldehyde units, which may comprise incorporated into the polymer up to 50, preferably up to 20% by weight of other amino-, amide-, hydroxyl- or carboxyl-containing thermosetting plastics on the one hand and aldehydes on the other hand, and which are characterized by the following properties:
a) the net specific gravity as specified in DIN 53 420 is between 4 and 80, preferably between 6 and 60 and in particular between 8 and 40 [g·l^{-1];}
b) the thermal conductivity as specified in DIN 52 612 is less than 0.06, preferably less than 0.05 and in particular less than 0.04 [W·m⁻¹·° K.⁻¹];
c) the compression strength value as specified in DIN 53 577 at 60% deflection, divided by the net specific gravity, is less than 0.3, preferably less than 0.2 [N·cm⁻²/g·l⁻¹], where, when the compression strength value at 60% deflection is determined, a recuperation of the foam to at least 70%, preferably at least 80% and in particular at least 90% of its original dimension must take place;
d) the modulus of elasticity determined by a method similar to DIN 50 423, divided by the net specific gravity, is less than 0.25, preferably less than 0.2 and in particular less than 0.15 [N·mm⁻²/g·l⁻¹];
e) the elongation at break as specified in DIN 53 423 is greater than 6, preferably greater than 9 and in particular greater than 12 [mm];
f) the ignitability as specified in DIN 4102 is at least normal, preferably difficult;
g) the tensile strength as specified in DIN 53 571 is preferably at least 0.07, in particular at least 0.1 N·mm⁻².

In a preferred embodiment, the plant substrate according to the invention exclusively comprises synthetic plant substrates.

In a further preferred embodiment, the plant substrate according to the invention comprises mineral soil.

In a further preferred embodiment, the plant substrate according to the invention does not comprise any further synthetic plant substrates or mineral soils.

In a further preferred embodiment, the foam is employed in comminuted form, for example in flocculated form. Such floccules preferably have a mean diameter of 1.5 to 75 mm, in particular 4 to 40 mm.

In a further preferred embodiment, the foam is employed in the form of a block.

In a preferred embodiment, the foam employed in accordance with the invention is a waste or recycled material.

If the substrate according to the invention is employed in comminuted form, it is possible for example to comminute foam pieces which are generated as off-cuts when cutting shaped articles or when manufacturing foam blocks or foam webs to give floccules.

The comminution of the foam pieces into floccules can be effected for example by tearing the foam pieces, by cutting or by punching. It is preferred to generate the floccules by tearing the foam pieces, since this gives rise to a large irregular surface.

In a preferred variant, the open-celled foam is saturated with a liquid, for example alcohols, ketones, liquid hydrocarbons or water, before it is cut or divided. It is preferred to use water.

Dividing can be effected using conventional comminution machines which are equipped with rotating blades or with crushers. Suitable comminution machines are, for example, mills such as ball mills, or Ultraturax, extruders.

Depending on the nature of the comminution machine or the speed of rotation of the blades, finely divided particle (powders) or cotton-wool-like pieces (floccules) can be obtained. In this manner, a water- or alcohol-soaked foam piece can be processed in a particularly simple and dust-free manner to give an aminoplast particle suspension. If desired, the suspension can subsequently be filtered or centrifuged and the resulting powder can subsequently be dried.

Waste or recycled materials can also be used when the product is used in the form of a block.

For example, EP-B 0 646 452 discloses a method of producing shaped foam pieces where off-cuts of open-celled melamine resin foam with a specific gravity of 5 to 100 g/l are comminuted to give floccules. These floccules, together with a binder, a curing agent and water, are used for preparing a flowable composition. The flowable composition is introduced into a sealed mold and compressed, in the mold, to a specific gravity of 15 to 120 g/l. Curing of the binder results in the molded material being set as a molded article.

Preferred is a method of producing blocks composed of foam pieces of at least one open-celled foam which comprises the following steps:

(a) comminution of the foam pieces to give floccules,
(b) compressing the floccules to give a composite material,
(C) mechanical linking of the floccules by stitching.

Linking the foam floccules by stitching avoids introducing further substances into the foam, which would otherwise be necessary.

Such a method is described in EP-A 1 764 204.

In order to avoid disposing of individual foam pieces which are obtained as off-cuts when cutting shaped articles or when producing foam blocks, these foam pieces are comminuted in accordance with the process according to the invention to give floccules.

The comminution of the foam pieces into floccules can be effected for example by tearing the foam pieces, by cutting or by punching. It is preferred to generate the floccules by tearing the foam pieces, since this gives rise to a large irregular surface, which makes possible a better linking of the individual floccules during the stitching process.

In order to be able to link the individual floccules by stitching to give a block, the floccules preferably have a size, in all three dimensions, in the range of from 3 to 250 mm, preferably in the range of from 5 to 100 mm and in particular in the range of from 10 to 50 mm.

Linking the floccules mechanically by stitching is preferably effected in the same manner as stitching fibers to give a nonwoven. Producing a nonwoven by stitching is known for example from DE-A 198 19 733. Here, removing the nonwoven from the needles is supported by the fact that a pressurized chamber is located on the side of the stripper which faces away from the nonwoven, from which chamber pressurized air flows towards the nonwoven along channels in the stripper, thus pushing the nonwoven from the stripper towards the stitching support. However, it is also possible to strip the nonwoven from the needles with the aid of the stripper, but without being supported by pressurized air.

Further suitable artificial substrates are, for example, organosynthetic foam resin based on urea (for example Hygromull®), closed-celled styromull or mixtures thereof (for example Hygropor®73), superabsorbers (crosslinked polyacrylates or crosslinked polyacrylamides (for example Luquasorb®)), anhydrous mineral components such as sand, gravel, expanded clay and clay granules (for example Seramis®). Such further artificial substrates are present in an amount of from 0 to 75% by weight, preferably 0 to 40% by weight, in particular 0 to 20% by weight.

For the purposes of the invention, a mineral soil is understood as meaning a soil which comprises ≦30% by weight of organic substance, i.e. humus and/or biomass. A content of ≧20% by weight, in particular ≧15% by weight, is preferred. The mineral soil content amounts to from 0 to 75% by weight, preferably from 0 to 40% by weight, in particular from 0 to 20% by weight.

The substrate according to the invention preferably comprises release systems comprising fertilizers and/or plant protection agents.

The fertilizers employed in the process according to the invention may take the form of straights or of compound fertilizers. Constituents of these fertilizers which are feasible are all customary fertilizer components, nitrogen sources which may be used being, for example, ammonium sulfate, ammonium nitrate, ammonium chloride, ammonia sulfa-nitrate, urea, cyanamide, dicyanodiamide, sodium nitrate, Chile saltpeter or calcium nitrate, and also slow-release fertilizers such as oxamide, urea/formaldehyde condensates, urea/acetaldehyde condensates or urea/glyoxal condensates, for example ureaform, acetylenediurea, isobutylidenediurea or crotonylidenediurea. It is also possible for compounds to be present which comprise one or more of the following plant nutrients: phosphorus, potassium, magnesium, calcium or sulfur, and compounds which comprise the trace elements boron, iron, copper, zinc, manganese or molybdenum. Examples of such compounds are monoammonium phosphate, diammonium phosphate, superphosphate, Thomas phosphate, triple superphosphate, dicalcium phosphate, potassium phosphate, partially or fully digested crude phosphates, potassium nitrate, potassium chloride, potassium sulfate, dipotassium phosphate, magnesium sulfate, magnesium chloride, kieserite, dolomite, lime, colemanite, boric acid, borax, iron sulfate, copper sulfate, zinc sulfate, manganese sulfate, ammonium molybdate or similar substances. Moreover, the fertilizers may comprise one or more active substances such as, for example, nitrification inhibitors, urease inhibitors, herbicides, fungicides, insecticides, growth regulators, hormones, pheromones or other plant protection agents or soil adjuvants in amounts of from 0.01 to 20% by weight, based on the fertilizer. Complexing agents such as EDTA or EDDHA may also be present.

It is preferred to use compound fertilizers, in particular slow-release compound fertilizers, which comprise for example compounds such as ureaform, acetylene-diurea, isobutylidenediurea or crotonylidenediurea as the nitrogen source. It is furthermore preferred to use coated fertilizers, where the fertilizer granules are coated with a thin polymer membrane. Coated fertilizers are distinguished by a delayed release of the nutrients and are known per se to the skilled worker.

Suitable plant protection agents are for example insecticides, fungicides, growth regulators and herbicides, if appropriate in combination with suitable safeners. Preferred are systemic active substances which are absorbed from the plants via the roots.

The release systems bring about a delayed release of the active substances, so that the plants may be supplied with nutrients and/or plant protection agents for the entire growth period, preferably for at least one year, in particular for two years.

Microencapsulated and other systems with a delayed release of active substance (slow-release formulations) are described, for example, in H. Mollet, A. Grubenmann, Formulation Technology, Wiley-VCH, Weinheim 2001, Controlled Release Pesticides, ACS Symp. Series, No. 53, Am. Chem. Soc., Washington D.C. 1977, WO 97/14308 and H. B. Scher, Controlled-release delivery systems for pesticides, Macel Dekker, Inc., New York 1999.

If release systems for active substances are present, they generally amount to from 0.01 to 20, preferably from 0.05 to 10% by weight.

Examples of such systems are container crops, window boxes.

The plants can be employed in the form of seed, slips or else in precultured form.

Moreover, the plant substrate is particularly suitable for all ornamental and container plants (woody species, perennials) and for various types of fruit and vegetables.

Moreover, the plant substrate is particularly suitable for use in greenhouses, in open-air containers, window boxes, plant containers, patio pots, grow-bags intended to be planted or sown, and as rooting medium for growing seedlings.

The plant substrate according to the invention may also be used as a soil conditioner, i.e. an additive to soils and other substrates.

The invention is illustrated in greater detail by the examples.

### EXAMPLES

Plastic pots size 13 were filled with the substrates of examples 1-4 and the comparative examples 1 and 2, and planted up with in each case one Chinese leaves seedling. The plants were fertilized and irrigated (fertigated) with a water-soluble whole-nutrient fertilizer (0.5% strength “Hakaphos® Spezial” solution NPK-fertilizer with Mg and trace nutrients). In accordance with agricultural practice, the plants were watered whenever variant 7 required water. In contrast, the submerged variants 4 and comparative example 2 were watered daily with fertigation solution until flowthrough was observed in order to test for resistance to overwatering. The pots were placed in the greenhouse at approximately 18-23° C.

The following results were obtained:

| Example No. | Substrate | Plant growth |
|---|---|---|
| 1 | MFF block | +++ |
| 2 | MFF floccules | +++ |
| 3 | MFF floccules + SAP | +++ |
| Comparative example 1 | Commercial potting compost | +++ |
| Comparative example 2 | Commercial potting compost, | + |
| | submerged | |
| 4 | MFF floccules, submerged | +++ |

MFF = melamine/formaldehyde foam (Basotect ®, BASF)
SAP = superabsorber
+ satisfactory, ++ good, +++ very good

Good plant growth was observed in examples 1, 2, 3 and the traditional potting compost (comparative example 1).

Under the conditions of daily overwatering (submerged conditions) with daily supplies of 100 ml nutrient solution, as in example 4 and comparative example 2, MFF floccules were shown to be a superior substrate to commercially available potting compost. As a result of the wet conditions in the commercially available peat-based substrate, the growth of the Chinese leaves plants was greatly retarded, and they achieved only one third of the fresh weight of the shoot of those plants which had been cultured in MFF floccules with a mean diameter of approximately 20 mm (example 4).

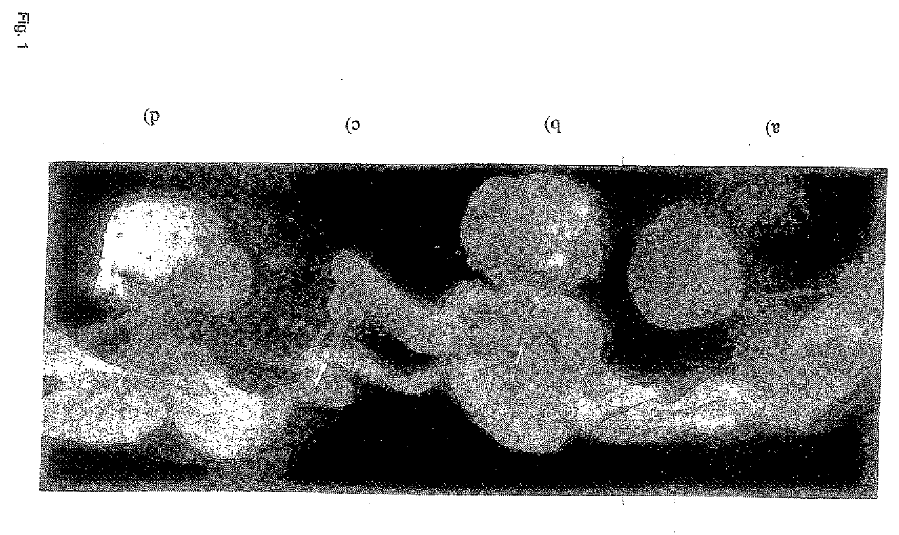

The FIG. 1 shows plants which were cultured in accordance with examples 2 (b) and 4 (d) and comparative examples 1 (a) and 2 (c).

1.-10. (canceled)

11. A plant substrate consisting of
(a) 75 to 100% by weight of an open-celled melamine/formaldehyde foam, and
(b) 0 to 25% by weight of one or more systems for releasing active substances and/or of other additives, where the open-celled melamine/formaldehyde foam is in the form of a block.

12. The plant substrate according to claim 11, where the melamine/formaldehyde foam is a waste or recycled material.

13. The plant substrate according to claim 11, where the net specific gravity of the melamine/formaldehyde foam is 4 to 100 g/l.

14. The plant substrate according to claim 11, further comprising a straight or a compound fertilizer.

15. The plant substrate according to claim 11, further comprising a plant protection agent from the group of insecticides, fungicides and growth regulators.

16. The plant substrate according to claim 12, where the net specific gravity of the melamine/formaldehyde foam is 4 to 100 g/l.

17. The plant substrate according to claim 16, further comprising a straight or a compound fertilizer.

18. The plant substrate according to claim 17, further comprising a plant protection agent from the group of insecticides, fungicides and growth regulators.

19. A plant substrate consisting of
(a) at least 80% by weight of an open-celled melamine/formaldehyde foam, and
(b) 0.01 to 20% by weight of one or more systems for releasing active substances and/or of other additives, where the open-celled melamine/formaldehyde foam is in the form of a block.

20. The plant substrate as claimed in claim 19, wherein of said one or more systems for releasing active substances and/or of other additives is present in an amount from 0.05 to 10% by weight.

21. A method of culturing plants, which comprises growing the plants in the plant substrate according to claim 11.

22. A method of culturing plants, which comprises growing the plants in the plant substrate according to claim 20.
